(19) United States
(12) Patent Application Publication
(10) Pub. No.: US 2022/0381994 A1
(43) Pub. Date: Dec. 1, 2022

(54) FIBER OPTIC CONNECTOR SPRING FORCE CONTROL SYSTEMS AND METHODS

(71) Applicant: CommScope Technologies LLC, Hickory, NC (US)

(72) Inventor: Randall Bobby Paul, Elizabethville, PA (US)

(21) Appl. No.: 17/825,921

(22) Filed: May 26, 2022

Related U.S. Application Data
(60) Provisional application No. 63/194,733, filed on May 28, 2021.

(51) Int. Cl. G02B 6/38

(52) U.S. Cl. CPC G02B 6/3821; G02B 6/3825

(57) ABSTRACT

A method of manufacturing a fiber optic connector with a desired ferrule biasing force by first providing a partially assembled fiber optic connector with a front housing slideably to a rear housing. The method includes pressing on a ferrule end face at the distal portion of ferrule with a force measuring device; moving the ferrule end face a predetermined distance relative to the front end of the front housing in a direction toward the rear housing while the force measuring device is pressing on the ferrule end face; moving the rear housing in a direction toward the front end of the front housing until the force measuring device measures a predetermined force.

### CROSS REFERENCE TO RELATED APPLICATION

This application claims the benefit of provisional application Ser. No. 63/194,733, filed May 28, 2021, which is incorporated herein by reference in its entirety.

### BACKGROUND OF THE INVENTION

Fiber optic connectors typically include a spring biased ferrule which holds one or more fiber optic cable ends. The ferrules of mating connectors typically engage one another to allow for signal transmission between fiber optic cable or cables secured to each of the respective ferrules.

The spring of each connector exerts a force on each of the ferrules so that the ferrules engage the respective end face of the opposing ferrule. The ferrule contact forces are sometimes important in order to meet an industry standard or pass industry testing. There is a need for systems and methods which control the connector spring force associated with a ferrule of each connector.

### SUMMARY OF THE INVENTION

In one aspect of the invention, the connector includes a variable press fit during assembly wherein a ferrule force is used as feedback during the press fit operation.

A method of manufacturing a fiber optic connector comprises the steps of: providing a partially assembled fiber optic connector including: a front housing; a rear housing; a ferrule and a hub; and a spring. The front housing and the rear housing are slideably mounted together to create an inner pocket for receiving the spring, the hub, and a proximal portion of the ferrule. A distal portion of the ferrule protrudes from a front end of the front housing. The spring biasing of the ferrule and the hub is biased in a direction toward the front end of the front housing.

The method further includes pressing on a ferrule end face at the distal portion of ferrule with a force measuring device; moving the ferrule end face a predetermined distance relative to the front end of the front housing in a direction toward a rear end of the rear housing while the force measuring device is pressing on the ferrule end face; moving the rear housing in a direction toward the front end of the front housing until the force measuring device measures a predetermined force.

### BRIEF DESCRIPTION OF THE FIGURES

FIG. 1 is a perspective view of an example fiber optic connector that is fully assembled.

FIG. 2 is an exploded perspective view of the connector of FIG. 1.

FIG. 3 is a side view of the connector of FIGS. 1 and 2.

FIG. 4 is a cross-sectional side view of the connector of FIG. 3.

FIG. 5 is a side view of the connector of FIGS. 1-4 in a partially assembled condition.

FIG. 6 is a cross-sectional side view of the connector of FIG. 5 in the partially assembled condition.

FIG. 7 is a cross-sectional side view of the connector of FIGS. 5 and 6 in the partially assembled condition, and showing in schematic view devices used in the assembly method.

### DETAILED DESCRIPTION

Some fiber optic connectors are assembled by mounting a front housing to a rear housing to contain an axially moveable ferrule which holds a fiber optic cable, and a hub which holds the ferrule. The ferrule, the hub, and the fiber are moveable axially against a spring within the connector.

In one example connector, assembly method and system according to the present disclosure, a spring pocket defined within the connector has a variable length when the front and rear housings of the connector are press fit together.

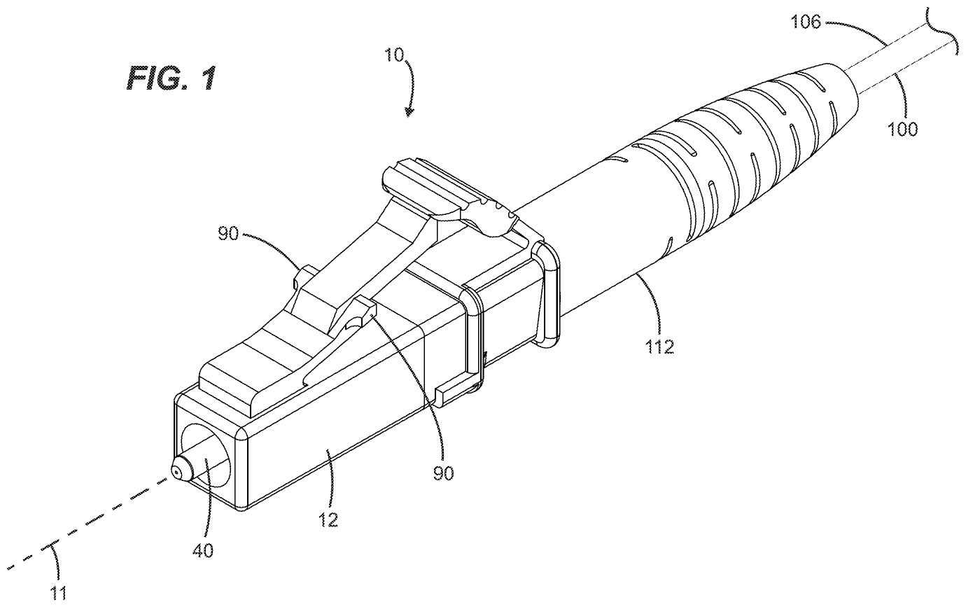

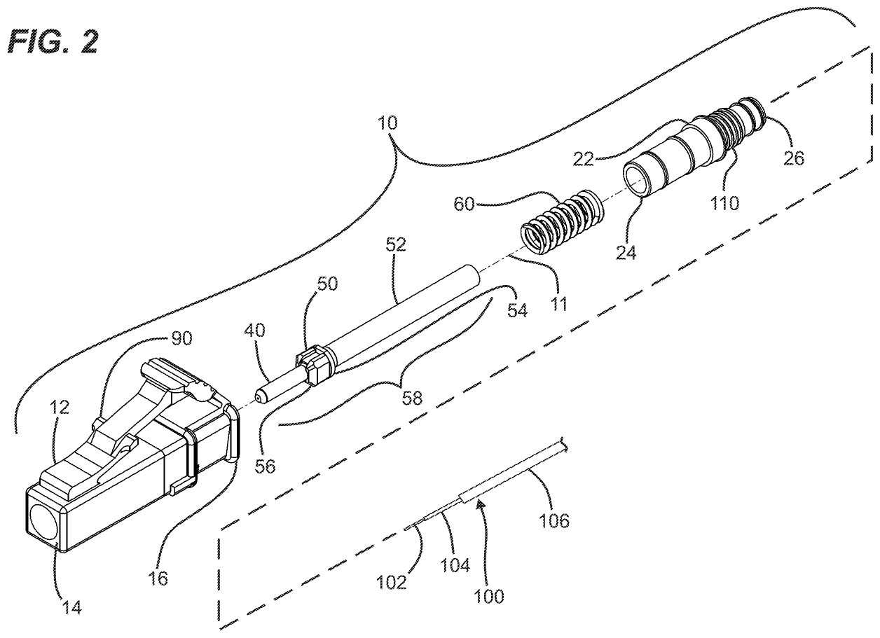

As shown in FIGS. 1-7, an example connector 10 includes a front housing 12 and a rear housing 22. The front housing 12 includes a front end 14 and a rear end 16. The rear housing 22 includes a front end 24 and a rear end 26. In the example connector 10, the front end 24 of rear housing 22 is received within an interior passage 30 of front housing 12.

During assembly, the front housing 12 and the rear housing 22 are slidably mounted together in a press fit operation to create the inner pocket for receiving the spring, the hub, and a proximal portion of the ferrule. A distal portion of the ferrule protrudes from a front end of the front housing.

Also received within connector 10 is a ferrule 40, a ferrule hub 50, and a spring 60. A rear tube 52 can extend from hub 50 in a direction away from ferrule 40. Rear tube 52, ferrule 40 and hub 50 form a ferrule and hub assembly 58.

An internal passage 70 extends from a front end 72 of connector 10 to a rear end 74. Passage 70 receives the fiber optic cable 100, including the fiber (core and cladding) 102, any coating 104, and any jacket 106 or other protective layers (e.g., yarn, a further jacket). See U.S. Pat. No. 10,942,317, herein fully incorporated by reference, as one example of a ferrule, hub and fiberoptic cable useable in the connector 10.

Rear housing 22 is shown as a type including a rear crimp surface 110 for being crimped to jacket 106 or other protective layers (e.g., yarn, a further jacket) by a crimp sleeve (not shown), and covered by a strain relief boot 112.

Spring 60 resides in a pocket 80 in front of a front shoulder 28 of rear housing 22. Spring 60 presses against shoulder 54 of hub 50 to bias ferrule 40 to the position shown in FIGS. 1, 3 and 4. In this position, a front 56 of hub 50 engages a shoulder 18 of front housing 12. Ferrule 40 is movable rearwardly against spring 60 when engaged with an opposing ferrule of a second connector aligned in an axial direction 11.

Example connector 10 is an LC style connector including a latch 90. Latch 90 latches to an adaptor which holds connector 10 in a mating position with a second similar connector at an opposite end of the adaptor. When mated in an adapter, both ferrules 40 of each connector 10 will be moved rearwardly against each respective spring 60 wherein the end face 42 of each ferrule 40 is engaged with one another, and the fiber 100 of each ferrule 40 is in axial alignment with the fiber of the opposing ferrule.

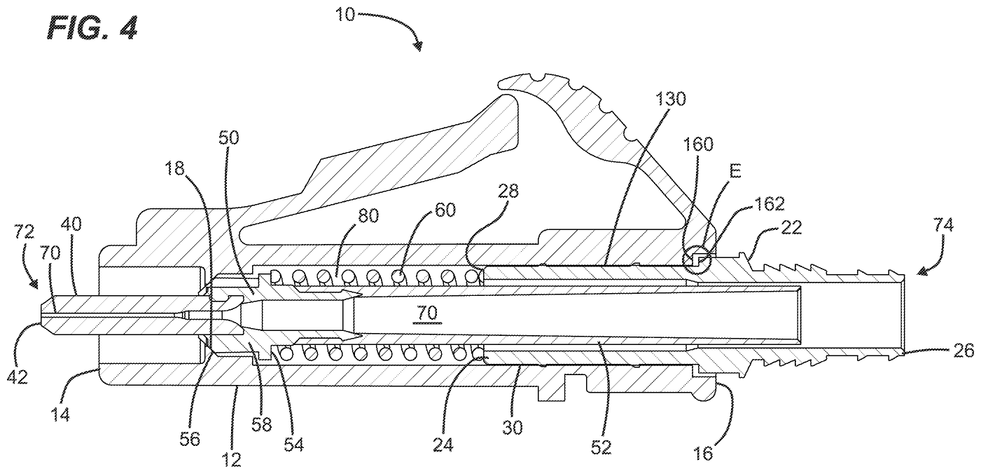

As shown in FIG. 4, the ferrule and hub assembly 58 is in the position when connector 10 is not connected for signal transmission to a second connector, such as by way of a fiber optic adapter.

If the spring force is not controlled, there may be too little spring force or too much spring force applied to each ferrule during deflection. If a connector is assembled by way of pressing or connecting a rear housing to a front housing in a predetermined position, the spring force may vary connector to connector due to tolerance issues associated with the various elements that form each connector 10. Too much compression of the spring 60 will result in too much force on the ferrule end face 42 when connected to another connector. Too little compression of the spring 60 will result in insufficient force on the ferrule end face when connected to another connector.

In one example, an LC connector is desired to have a certain force at a certain amount of deflection of the ferrule end face 42 with respect to a landmark on the connector 10. In one example, if the ferrule is compressed to 9.8 millimeters relative to a latch surface 92 the latch 92, it is desirable to have a force of approximately 6 Newtons.

In the preferred method and system, rear housing 22 and front housing 12 can be press fit together in variable positions. A hydraulic press or other device may be used to press fit the connector parts together. The front housing 12 is held to the rear housing 22 along interface 130 after the press fit operation. If the ferrule deflection is set at a predetermined distance, and the force is measured during the press fit operation, then the press fit operation can be controlled to a desired setting when a measured force is reached. Each connector may press fit together to a different depth, but each connector would have the same ferrule force for a similar amount of ferrule deflection.

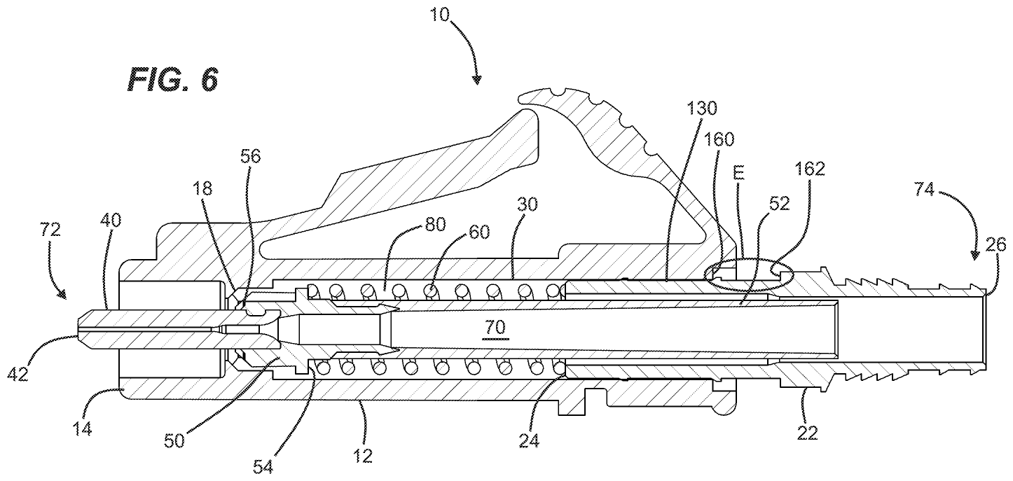

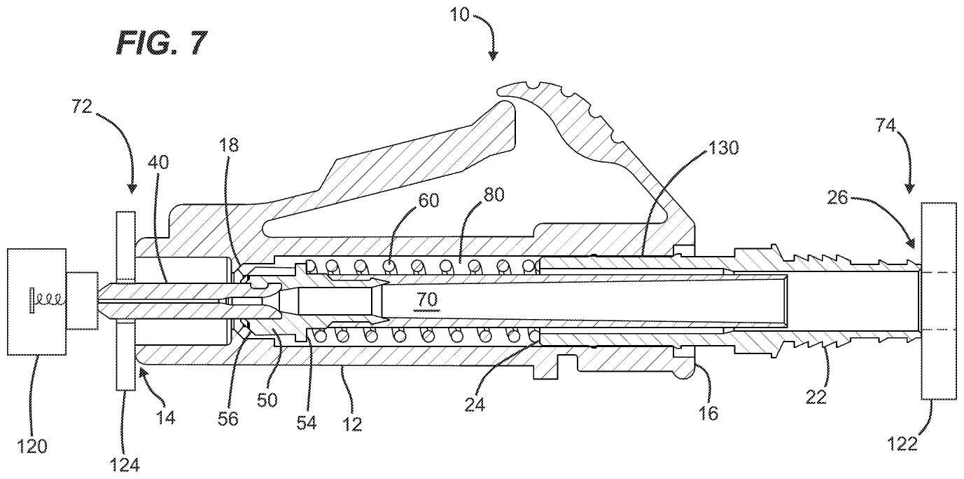

FIG. 7 shows a force gauge 120 engaging ferrule end face 42. FIG. 7 further shows a first surface 122 and a second surface 124 shown schematically on opposite ends of connector 100. In one example, first surface 122 is moved toward second surface 124 to press rear housing 22 into front housing 12. The pressing operation is continued until a desired force is noted on force gauge 120 for a desired amount of deflection for hub 50 and ferrule 40. See FIG. 4. Further pressing of the rear housing 22 into the front housing 12 is possible, but is not desired as the biasing force of spring 60 would exceed the desired force at the desired amount of ferrule and hub assembly deflection. FIGS. 6 and 7 show the ferrule and hub assembly 58 spaced from shoulder 18, as in a connected position with a second connector, and generating force on the ferrule end faces.

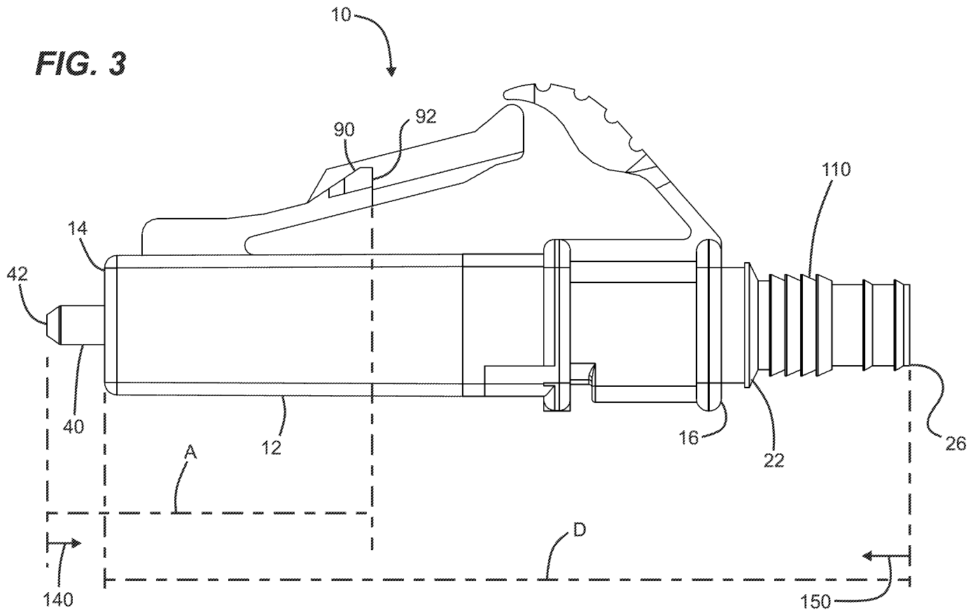

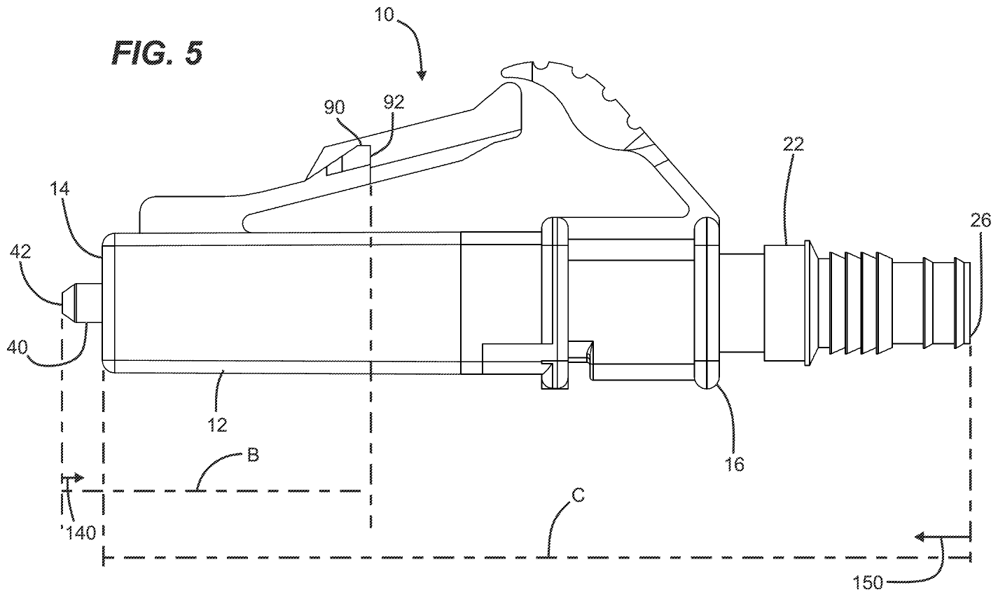

Referring to FIGS. 3-7, ferrule 40 has a maximum extension position shown in FIGS. 3 and 4, and a selected pressed in position shown in FIGS. 5-7. See arrow 140. The pressed in position of FIGS. 5-7 is selected as a desired position during assembly. The pressed in position may also be the position, or somewhere close to that position when the connector is later mated with another connector.

During assembly, the pressed in position is measured with respect to a landmark on the front housing 12, such as the front end 14 or the latch surface 92. Compare the maximum extension position of FIG. 3, line or distance A, with the pressed in position of FIG. 5, line or distance B, wherein line B is shorter than line A.

During assembly, the front housing 12 is partially inserted in the rear housing 22 in the starting position as in FIGS. 5-7. Line or distance C represents the length of connector 100 at that time. Line or distance D shows the final position and length of the connector for front housing 12 and rear housing 22 pressed further together in the direction of arrow 150, and represented by line D. Line D is shorter than line C. As shown in FIG. 6 in the partially inserted position at area E, shoulder 162 of rear housing 22 is spaced from shoulder 160 of front housing 12, a distance greater than in the final position of FIG. 4.

The position of FIG. 6 would not generate enough spring force and contact force for ferrule end face 42 at the desired deflection position. Also, it is to be noted that front and rear housings 12, 22 could be pressed further together as show in FIG. 4, area E, (see remaining space between shoulders 160, 162), but such further insertion of front and rear housings 12, 22 would generate too much spring force and contact force for the ferrule end face at the desired deflection position.

With the disclosed connector, system and method, the variable position press fit connector used during the assembly method allows a ferrule force to be used as feedback during the press fitting operation, to achieve the desired spring force a desired ferrule deflection position.

What is claimed is:

1. A method of manufacturing a fiber optic connector comprising the steps of:
providing a partially assembled fiber optic connector including:
a front housing;
a rear housing;
a ferrule and a hub;
a spring;
wherein the front housing and the rear housing are slideably mounted together to create an inner pocket for receiving the spring, the hub, and a proximal portion of the ferrule;
wherein a distal portion of the ferrule protrudes from a front end of the front housing;
wherein the spring biasing of the ferrule and the hub is biasing in a direction toward the front end of the front housing;
pressing on a ferrule end face at the distal portion of ferrule with a force measuring device;
moving the ferrule end face a predetermined distance relative to the front end of the front housing in a direction toward a rear end of the rear housing while the force measuring device is pressing on the ferrule end face;
moving the rear housing in a direction toward the front end of the front housing until the force measuring device measures a predetermined force.

2. The method of claim 1, further comprising inserting a fiber optic cable into the fiber optic connector.

3. A connector made in accordance with the method of claim 1.

4. A connector made in accordance with the method of claim 2.

5. A plurality of connectors made in accordance with the method of claim 1, wherein at least two connectors have the respective front housing and rear housing press fit together to a different depth, and the at least two connectors each have the same ferrule force for the same amount of ferrule deflection.

6. A plurality of connectors made in accordance with the method of claim 2, wherein at least two connectors have the respective front housing and rear housing press fit together to a different depth, and the at least two connectors each have the same ferrule force for the same amount of ferrule deflection.

7. A method of manufacturing a fiber optic connector comprising the steps of:
providing a partially assembled fiber optic connector including:
a front housing;
a rear housing;
a ferrule and a hub;
a spring;
wherein the front housing and the rear housing are slideably mounted together to create an inner pocket for receiving the spring, the hub, and a proximal portion of the ferrule;
wherein a distal portion of the ferrule protrudes from a front end of the front housing;
wherein the spring biasing of the ferrule and the hub is biasing in a direction toward the front end of the front housing;
pressing on a ferrule end face at the distal portion of ferrule;
measuring the pressing force on the ferrule with a force measuring device;
moving the ferrule end face a predetermined distance relative to the front end of the front housing in a direction toward a rear end of the rear housing while the force measuring device is measuring the pressing force on the ferrule end face;
moving the rear housing in a direction toward the front end of the front housing until the force measuring device measures a predetermined force.

8. The method of claim 7, further comprising inserting a fiber optic cable into the fiber optic connector.

9. A connector made in accordance with the method of claim 7.

10. A connector made in accordance with the method of claim 8.

11. A plurality of connectors made in accordance with the method of claim 7, wherein at least two connectors have the respective front housing and rear housing press fit together to a different depth, and the at least two connectors each have the same ferrule force for the same amount of ferrule deflection.

12. A plurality of connectors made in accordance with the method of claim 8, wherein at least two connectors have the respective front housing and rear housing press fit together to a different depth, and the at least two connectors each have the same ferrule force for the same amount of ferrule deflection.
